(19) United States
(12) Patent Application Publication
(10) Pub. No.: US 2025/0106316 A1
(43) Pub. Date: Mar. 27, 2025

(54) ROTARY KICKSTAND AND MOBILE PHONE CASE

(71) Applicant: Guangzhou Roiskin Technology Company, Guangzhou (CN)

(72) Inventor: Yuying Lin, Guangzhou (CN)

(21) Appl. No.: 18/381,254

(22) Filed: Oct. 18, 2023

(30) Foreign Application Priority Data
Sep. 27, 2023 (CN) 202322652302.4

(51) Int. Cl. H04M 1/02; F16M 11/04; F16M 11/10; F16M 11/16

(52) U.S. Cl. CPC H04M 1/0283; F16M 11/045; F16M 11/105; F16M 11/16; F16M 2200/065

(57) ABSTRACT

The invention discloses a rotary kickstand and mobile phone case, the damping device is arranged to realize rotatable connection between the ring pull and the base, such that the ring pull can be opened or closed around the joint with the base as required, thus meeting the multi-angle use requirements of users; through the magnetic device arranged on the lower surface of the base, use requirements of users in various scenarios can be met; and through the stop ring arranged on the side edge of the base and detachably connected to the base, the rotary kickstand can be installed easily, and the stability after installation is guaranteed.

### CROSS REFERENCE TO RELATED APPLICATIONS

The present application claims the benefit of Chinese Patent Application No. 202322652302.4 filed on Sep. 27, 2023, the contents of which are incorporated herein by reference in their entirety.

### BACKGROUND OF THE INVENTION

### 1. Technical Field

The invention belongs to the field of mobile phone cases, and more particularly, relates to a rotary kickstand and a mobile phone case.

### 2. Description of Related Art

Mobile phone cases on the current market are mainly used for protecting mobile phones when the mobile phones fall off. With the diversification of the functions of mobile phones, the mobile phones may be used in different occasions and places to satisfy the daily use requirements of users. Therefore, there is an urgent demand for a mobile phone case which can provide convenience for users in daily use.

### BRIEF SUMMARY OF THE INVENTION

The main objective of the invention is to provide a rotary kickstand and a mobile phone case, which can provide convenience for users in daily use.

A rotary kickstand, comprising a base and a ring pull, the base and the ring pull being rotatably connected, wherein a first opening for receiving the ring pull is formed in the base, a damping device is arranged at a joint of the ring pull and the base, a magnetic device is arranged on a lower surface of the base, a groove is arranged along a side edge of the base, a stop ring is arranged in the groove and is detachably connected to the base, and a width of the stop ring is greater than a depth of the groove.

A rotary kickstand, the damping device comprises a plurality of damping shafts, and each of the damping shafts has an end threadedly connected to the base, as well as an end connected to the ring pull.

A rotary kickstand, a plane is arranged at the end, connected to the ring pull, of each of the damping shafts, and a plurality of through holes are formed in the other end of each of the damping shafts at intervals.

A rotary kickstand, the magnetic device is inlaid in the base and comprises a plurality of magnets and a cover, a cavity is formed in the lower surface of the base, the plurality of magnets are arranged in the cavity at intervals, and the cover is located above the plurality of magnets.

A rotary kickstand, a crescent groove for pulling out the ring pull is formed in an end, away from the damping device, of the base, and a step groove is formed in a position, corresponding to the crescent groove, of the ring pull.

A rotary kickstand, wherein the base and the ring pull are both made from a PC material.

A rotary kickstand, a second opening facilitating disassembly is formed in the stop ring close to the damping device.

A rotary kickstand, the stop ring is made from stainless steel.

A mobile phone case, comprising a shell, the mobile phone case uses the above rotary kickstand, and a mounting groove for receiving the rotary kickstand is formed in the shell.

One of the above technical solutions of the invention has at least one of the following advantages or beneficial effects:

In the invention, the damping device is arranged to realize rotatable connection between the ring pull and the base, such that the ring pull can be opened or closed around the joint with the base as required, thus meeting the multi-angle use requirements of users; through the magnetic device arranged on the lower surface of the base, use requirements of users in various scenarios can be met; and through the stop ring arranged on the side edge of the base and detachably connected to the base, the rotary kickstand can be installed easily, and the stability after installation is guaranteed.

### BRIEF DESCRIPTION OF THE SEVERAL VIEWS OF THE DRAWINGS

The invention will be further described below in conjunction with accompanying drawings and embodiments.

FIG. 1 is an exploded view of one embodiment of the invention;

FIG. 2 is an overall structural view of one embodiment of the invention;

FIG. 3 is a structural view of a ring pull according to one embodiment of the invention;

FIG. 4 is a structural view of damping shafts according to one embodiment of the invention;

FIG. 5 is an assembled view of one embodiment of the invention;

FIG. 6 is an assembled exploded view of one embodiment of the invention;

FIG. 7 is an assembled view of another embodiment of the invention; and

FIG. 8 is an assembled exploded view of another embodiment of the invention.

### DETAILED DESCRIPTION OF THE INVENTION

Many different embodiments or examples are provided in the disclosure below to implement different solutions of the invention.

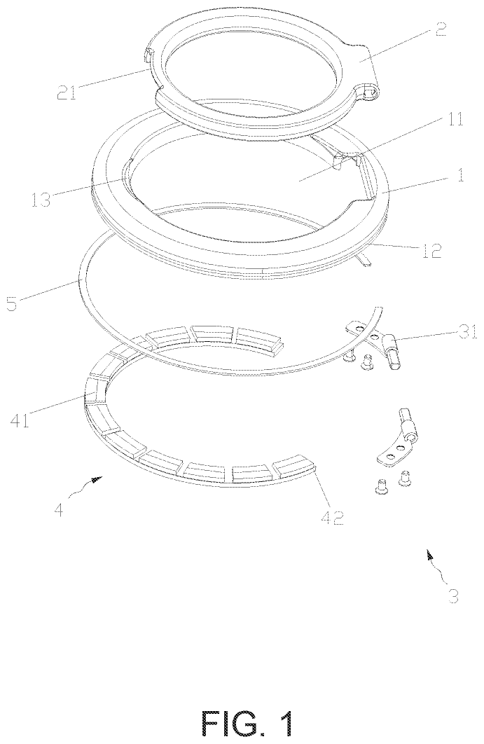

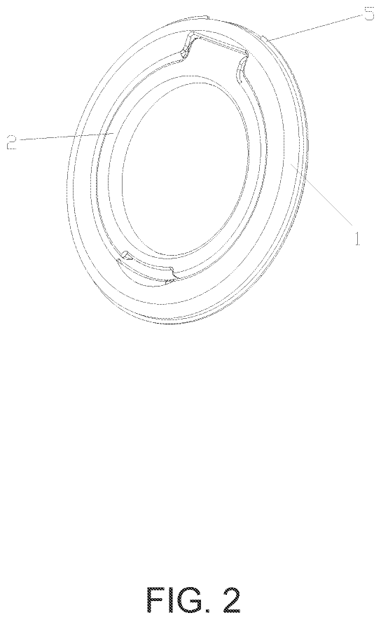

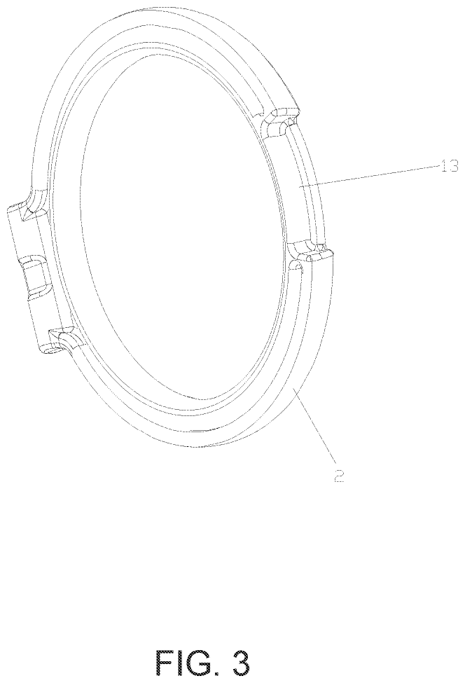

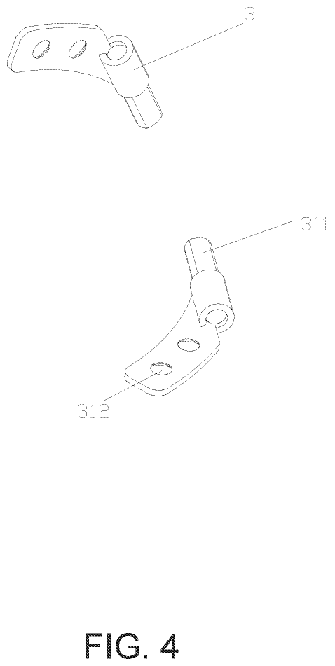

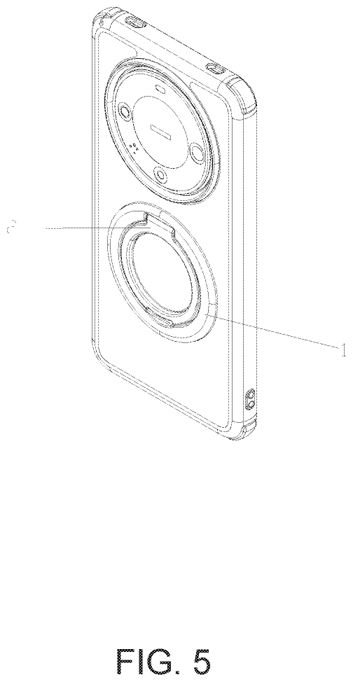

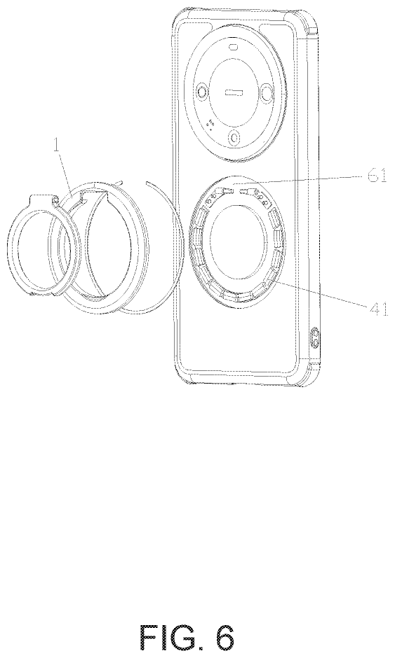

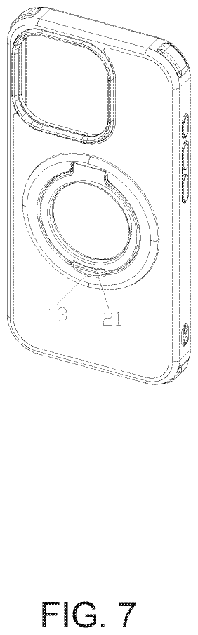

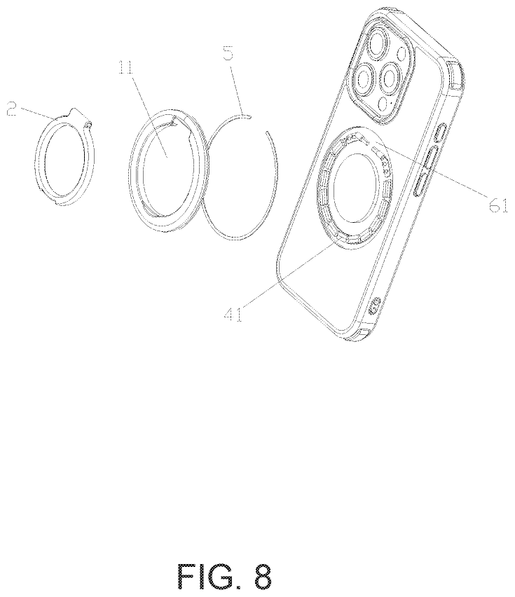

Referring to FIG. 1-FIG. 8, a rotary kickstand comprises a base 1 and a ring pull 2, wherein the base 1 and the ring pull 2 are rotatably connected, a first opening 11 for receiving the ring pull 2 is formed in the base 1, a crescent groove 13 for pulling out the ring pull 2 is formed in an end, away from a damping device 3, of the base 1, and a step groove 21 is formed in a position, corresponding to the crescent groove 13, of the ring pull 2. After being pulled out, the ring pull 2 is rotated and stabilized at a suitable angle under the action of damping shafts 31, and makes contact with the horizontal plane by means of two protrusions of the step groove 21, such that a mobile phone is stabilized.

In one embodiment of the invention, the damping device 3 is arranged at a joint of the ring pull 2 and the base 1, wherein the damping device 3 comprises two damping shafts 31, each of the two damping shafts 31 has an end threadedly connected to the base 1, as well as an end connected to the ring pull 2. The damping shafts 31 allow the ring pull 2 to be opened and closed to any angle within a permissible range and can prevent the fingers of users from being pinched.

In one embodiment of the invention, planes 311 are arranged at the ends, connected to the ring pull 2, of the damping shafts 31 respectively, such that the ring pull 2 can be opened and closed more easily; two through holes 312 are formed in the other end of each damping shaft 31, and each damping shaft 31 is threadedly connected to the base 1 through the two through holes 312, thus guaranteeing the connection strength and facilitating disassembly.

In one embodiment of the invention, a magnetic device 4 is arranged on a lower surface of the base 1 and is inlaid in the base 1. After the magnetic device 4 is mounted on the lower surface of the base 1, the lower surface of the base 1 does not protrude. Wherein, the magnetic device 4 comprises twelve magnets 41 which form a circle, a cavity is formed in the lower surface of the base 1, the twelve magnets 41 are arranged in the cavity at intervals, and a cover 42 easy to open is arranged above the twelve magnets 41 to facilitate disassembly and replacement.

In one embodiment of the invention, a mobile phone case uses the rotary kickstand and comprises a shell 6, wherein a mounting groove 61 for receiving the rotary kickstand is formed in the shell 6, and a clamping groove allowing a stop ring 5 to be inserted therein is arranged along an inner wall of the mounting groove 61. The rotary kickstand can rotate freely through adaptive connection of the stop ring 5 and the clamping groove.

In one embodiment of the invention, a groove 12 is arranged along a side edge of the base 1, a stop ring 5 is arranged in the groove 12 and is detachably connected to the base 1, a clamping groove allowing the stop ring 5 to be inserted therein is arranged along an inner wall of the mounting groove 61, and the width of the stop ring 5 is greater than the depth of the groove 12. In this way, after the rotary kickstand is mounted on the mobile phone case, part of the stop ring 5 is located in the groove 12, and the other part of the stop ring 5 is located in the clamping groove, thus fixing the rotary kickstand and the mobile phone case together.

In one embodiment of the invention, since part of the stop ring 5 is located in the groove 12 and the other part of the stop ring 5 is located in the clamping groove, the stop ring 5 is made from stainless steel to guarantee sufficient strength of the joint of the rotary kickstand and the mobile phone case.

In one embodiment of the invention, when holding a mobile phone during exercise, users can pull out the ring pull 2 upward by means of the step groove 21 and the crescent groove 13 and then stretch their fingers across the ring pull 2 to hold the mobile phone. In this way, it is further guaranteed that the mobile phone will not fall off accidentally;

When users need to horizontally or vertically erect the mobile phone to liberate their hands, users can stretch their fingers into the crescent groove 13 and pull out the ring pull 2 upward by means of the step groove 21, then the rotary kickstand can be opened or closed within 0-110° by means of the damping device 3, and the rotary kickstand can be mounted in the mounting groove 61 of the mobile phone case by means of the stop ring 5 and the groove 12 and can rotate within 360° to meet multi-angle use requirements of users.

In one embodiment of the invention, the base 1 and the ring pull 2 are both made from a PC material, thus having certain hardness; and the base 1 and the ring pull 2 are low in prices, and thus can be detached and replaced regularly.

What is claimed is:

1. A rotary kickstand, comprising a base (1) and a ring pull (2), the base (1) and the ring pull (2) being rotatably connected, wherein a first opening (11) for receiving the ring pull (2) is formed in the base (1), a damping device (3) is arranged at a joint of the ring pull (2) and the base (1), a magnetic device (4) is arranged on a lower surface of the base (1), a groove (12) is arranged along a side edge of the base (1), a stop ring (5) is arranged in the groove (12) and is detachably connected to the base (1), and a width of the stop ring (5) is greater than a depth of the groove (12).

2. The rotary kickstand according to claim 1, wherein the damping device (3) comprises a plurality of damping shafts (31), and each of the damping shafts (31) has an end threadedly connected to the base (1), as well as an end connected to the ring pull (2).

3. The rotary kickstand according to claim 2, wherein a plane (311) is arranged at the end, connected to the ring pull (2), of each of the damping shafts (31), and a plurality of through holes (312) are formed in the other end of each of the damping shafts (31) at intervals.

4. The rotary kickstand according to claim 1, wherein the magnetic device (4) is inlaid in the base (1) and comprises a plurality of magnets (41) and a cover (42), a cavity is formed in the lower surface of the base (1), the plurality of magnets (41) are arranged in the cavity at intervals, and the cover (42) is located above the plurality of magnets (41).

5. The rotary kickstand according to claim 1, wherein a crescent groove (13) for pulling out the ring pull (2) is formed in an end, away from the damping device (3), of the base (1), and a step groove (21) is formed in a position, corresponding to the crescent groove (13), of the ring pull (2).

6. The rotary kickstand according to claim 5, wherein the base (1) and the ring pull (2) are both made from a PC material.

7. The rotary kickstand according to claim 1, wherein a second opening (51) facilitating disassembly is formed in the stop ring (5) close to the damping device (3).

8. The rotary kickstand according to claim 7, wherein the stop ring (5) is made from stainless steel.

9. A mobile phone case, comprising a shell (6), wherein the mobile phone case uses the rotary kickstand according to claim 1, and a mounting groove (61) for receiving the rotary kickstand is formed in the shell (6).

10. A mobile phone case, comprising a shell (6), wherein the mobile phone case uses the rotary kickstand according to claim 2, and a mounting groove (61) for receiving the rotary kickstand is formed in the shell (6).

11. A mobile phone case, comprising a shell (6), wherein the mobile phone case uses the rotary kickstand according to claim 3, and a mounting groove (61) for receiving the rotary kickstand is formed in the shell (6).

12. A mobile phone case, comprising a shell (6), wherein the mobile phone case uses the rotary kickstand according to claim 4, and a mounting groove (61) for receiving the rotary kickstand is formed in the shell (6).

13. A mobile phone case, comprising a shell (6), wherein the mobile phone case uses the rotary kickstand according to claim 5, and a mounting groove (61) for receiving the rotary kickstand is formed in the shell (6).

14. A mobile phone case, comprising a shell (6), wherein the mobile phone case uses the rotary kickstand according to claim 6, and a mounting groove (61) for receiving the rotary kickstand is formed in the shell (6).

15. A mobile phone case, comprising a shell (6), wherein the mobile phone case uses the rotary kickstand according to claim 7, and a mounting groove (61) for receiving the rotary kickstand is formed in the shell (6).

16. A mobile phone case, comprising a shell (6), wherein the mobile phone case uses the rotary kickstand according to claim 8, and a mounting groove (61) for receiving the rotary kickstand is formed in the shell (6).
